(19) United States
(12) Patent Application Publication
(10) Pub. No.: US 2026/0317516 A1
(43) Pub. Date: Oct. 15, 2026

(54) SUSTAINABLE BIOCOMPOSITE MATERIAL AND PREPARATION THEREOF

(71) Applicant: United Arab Emirates University, Al Ain (AE)

(72) Inventors: Waleed AHMED, Al Ain (AE); Noura AL MAZROUEI, Al Ain (AE); Ali AL-MARZOUQI, Al Ain (AE)

(21) Appl. No.: 19/178,396

(22) Filed: Apr. 14, 2025

(51) Int. Cl. C08K 11/00; C08G 63/08; C08K 3/36

(52) U.S. Cl. CPC C08K 11/00; C08G 63/08; C08K 3/36

(57) ABSTRACT

The present invention provides a sustainable biocomposite material to overcome the environmental carbon footprint that arises from the use of hazardous constructional materials. The composite material of the present invention functions as a super insulator to reduce heat absorption and preserve the natural resources. More particularly, the present invention provides a sustainable bio composite material comprising biodegradable polymer, and a combination of fillers selected from the group consisting of volcanic stone, plant biomass, and silica. The present invention also provides a process of preparation of the biocomposite material comprising the biodegradable polymer waste and a combination of fillers obtained from naturally abundant waste material. Additionally, the present invention provides a structurally reinforced composite panel comprising a first layer and a second layer, comprising the biodegradable polymer. Besides thermal insulation, the composite material provides excellent toughness and elastic modulus.

### FIELD OF THE INVENTION

The present invention relates to a sustainable biocomposite material that functions as a super insulator to reduce heat absorption and preserve the natural resources. More particularly, the present invention relates to a sustainable biocomposite material comprising a biodegradable polymer matrix; and a combination of fillers selected from the group consisting of volcanic stone, plant biomass, and silica. The present invention also relates to a process of preparation of a hybrid biocomposite material comprising the biodegradable polymer waste and a combination of fillers. Besides thermal insulation, the composite material provides excellent toughness and elastic modulus.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Modern construction materials are environmentally unfriendly and are a great causative agent to pollution and climate change because they release high CO₂ emissions during their production and disposal. Asbestos and formaldehyde are especially dangerous because they emit toxic substances, are indestructible, and consume numerous resources to produce. While crucial for economic development and urbanization, the construction industry is a significant contributor to environmental degradation. As the concept of sustainability spreads worldwide, there is a concern with ways of minimizing the environmental effects of construction operations and materials. Pollution from construction and landfills serve as one of the prime causes for environmental pollution. To overcome such issues, the construction industry has shifted its focus towards sustainable measures that involve use of bio-based materials that serve as durable and hard construction materials and are rather promising for the construction industry.

Construction operations and the disposal of construction waste in dump sites are activities that are well-known pollutive activities with serious and lasting effects on the environment. Through construction activities and poor waste disposal, material found in construction have dangerous impacts on the environment in that they can contaminate soil and water resources (Hebel & Heisel, 2017). Some of the common pollutants include heavy metal particles from paints and treated timber, volatile organic compounds from adhesives, and finishes, asbestos fibers from old buildings, particulate matter from cement manufacture and different kinds of chemicals used in manufacturing various materials (Shukla et al., 2023). Also, CO₂ emissions from the hazardous materials used in construction are becoming increasingly tied to climate change, necessitating better materials. According to Khaiyum et al. (2023), concrete production gives about 5 to 8% of total CO₂ emissions, primarily because cement is a highly energy-demanding material. Also, Wang et al. (2021) discloses that mainly used construction materials, such as asphalt and steel, emit substantial measures of greenhouse gases throughout the lifetime of a building, thus highlighting the construction industry's role in deepening the environmental calamity. The mining, refining, and movement of these harmful substances also escalate carbon footprint and, thus, climate volatility (Labaran et al., 2022). Reducing emissions related to construction activities primarily through rejecting the use and disposal of hazardous materials is an area where the industry can influence its levels of climate change. Modern construction materials cause climate change, easily affect air quality, and deplete natural resources. This urgency to reduce construction-related CO₂ emissions requires shifting from these materials with more environmental harm. This has made society look for environmentally friendly products to help support the injured environment. Thus, a model for sustainable development to incorporate green construction principles, reduce the use of non-renewable resources, and reduce the impact on the environment is being considered to curb environmental harm.

Bio-polymers used in construction is one of the areas with great potential in realizing sustainable construction (Ramesh et al., 2017). Biopolymers are based on renewable natural materials and perform significantly better than the polymers developed from petroleum. They are usually less energy-intensive in production and can be carbon-free or even carbon-creative, (Agrela et al., 2019). Most biopolymers are biodegradable, meaning they have low environmental concerns in the long run, and the biopolymers contain lower quantities of toxic substances, enhancing indoor air quality and lowering pollution potentials (Tripathi et al., 2019). Biopolymers and bio composites appear to have significant potential for use in construction, replacing conventional fossil fuel-based products, primarily due to their environmental advantages and relatively low levels of carbon emissions. Natural polymers, including cellulose, starch, and lignin, drawn from renewable resources, have the eco-friendly characteristics of being biodegradable and require less energy in their production than the reference material (Mariana et al., 2021). Also, biopolymers reinforced with natural fibers such as hemp, flax, or jute show excellent strength/weight ratio and thermal stability, allowing their use in load-bearing applications (Shuvo et al., 2021). Besides enhancing construction sustainability, they reduce waste and energy use as the world seeks to reduce Geen-house gas (CHG) emissions (Almusaed et al., 2024). However, issues like cost and long-term performance remain a problem, with current research focused on improving these materials for broader use and showing that they can revolutionize construction and push towards a more sustainability-minded future.

Given the impact of the construction materials contributing to the environmental carbon print, development of sustainable concrete materials is of utmost necessity to curb the environmental carbon load. Thus, there remain an unmet need for providing a sustainable composite material that can be successfully employed for development of composite structures, reinforced composite panel, thermally resistant composite construction panels that would exhibit excellent elastic modulus and toughness imparting strength to the construction materials. The present invention seeks to address at least some of these issues.

### SUMMARY OF THE INVENTION

According to a first aspect of the present invention, there is provided a biocomposite material comprising a biodegradable polymer matrix; and a combination of fillers selected from the group consisting of volcanic stone, plant biomass, and silica.

The present inventors have surprisingly discovered that the biocomposite material according to the present invention boasts several key features that set it apart as a sustainable and high-performance biocomposite. By mixing a combination of fillers with the biodegradable polymer, the resultant biocomposite material exhibits several surprising advantages over conventional materials, having high thermal insulation, along with excellent toughness and elastic modulus. Furthermore, a sustainable biocomposite material is discovered herein making a thermally efficient construction material, a construction material for marine application, a prefabricated construction panel, corrosion-resistant composite material.

According to a second aspect of the present invention, there is provided a method of manufacturing a biocomposite material. The method comprises the steps of: obtaining a biodegradable polymer; obtaining at least one filler selected from volcanic stone, plant biomass, and silica, or combinations thereof; mixing the biodegradable polymer and the at least one filler to form a biodegradable polymer matrix; and molding the biodegradable polymer matrix to form the biocomposite material.

According to a third aspect of the present invention, there is provided a structurally reinforced composite panel comprising a first layer comprising a first biodegradable polymer matrix and a volcanic stone; and a second layer comprising a second biodegradable polymer matrix and a plant biomass. The structurally reinforced composite panel may comprise a biocomposite material according to the first aspect of the present invention.

According to a fourth aspect of the present invention, there is provided a method of manufacturing a structurally reinforced composite panel, comprising the steps of: feeding a first biodegradable polymer matrix and a volcanic stone in an extruder and extruding as a mixture to form a first layer; and feeding a second biodegradable polymer matrix and a plant biomass in an extruder and extruding as a mixture to form a second layer; wherein the first layer and the second layer are extruded simultaneously with the first layer on top of the second layer to form the structurally reinforced composite panel.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a schematic representation describing the process for preparation of a biocomposite material, in accordance with the present invention.

FIG. 2 illustrates a schematic representation of the process design of dual layered composites, in accordance with the present invention.

FIG. 3 illustrates the layers constituting the composite, wherein (a) illustrates the first layer composite (PLA and VSMGP), and (b) illustrates the second layer composite (PLA, VSMGP, Palm waste), in accordance with the present invention.

FIG. 4 illustrates (a) Stainless steel square moulds, and (b) Stainless steel cylindrical mould, in accordance with the present invention.

FIG. 5 illustrates a comparison of the compression strength of the composites, in accordance with the present invention.

FIG. 6 illustrates a comparison of the yield strength of the composites, in accordance with the present invention.

FIG. 7 illustrates a comparison of the elastic modulus of the composites, in accordance with the present invention.

FIG. 8 illustrates comparison of the toughness of the composites, in accordance with the present invention.

FIG. 9 illustrates comparison of the thermal insulation of the composites, in accordance with the present invention.

Reference is made to the accompanying figures throughout the specification, which form a part hereof, and which is shown by way of illustration specific embodiments by which the invention may be practiced. It is to be understood that other embodiments may be utilized and logical changes may be made without departing from the scope of the present invention. The following detailed description and examples, therefore, is not to be taken in a limiting sense, and the scope of the present invention is defined by the appended claims.

### DETAILED DESCRIPTION

For the purposes of the present invention, the following terms are defined below:

The articles “a” and “an” are used herein to refer to one or to more than one (i.e. to at least one) of the grammatical object of the article. By way of example, “an element” means one element or more than one element.

As used herein, the term “comprises” or “comprising” is generally used in the sense of include, that is to say permitting the presence of one or more features or components.

As used herein, the terms “optional” or “optionally” mean that the subsequently described event or circumstance may occur or may not occur, and that the description includes instances where the event or circumstance occurs as well as instances in which it does not.

The term plant biomass refers to materials made from natural fibers (like wood, straw, or plant fibers) combined with other biodegradable materials. These materials are more environmentally friendly than traditional composites because they come from renewable sources and can break down over time.

Each embodiment is provided by way of explanation of the invention and not by way of limitation of the invention. In fact, it will be apparent to those skilled in the art that various modifications and variations can be made to the compounds, and methods described herein without departing from the scope or spirit of the invention. For instance, features illustrated or described as part of one embodiment can be applied to another embodiment to yield a still further embodiment. Thus, it is intended that the present invention includes such modifications and variations and their equivalents.

Other objects, feature, and aspects of the present invention are disclosed in or are obvious from, the following detailed description. It is to be understood by one of ordinary skill in the art that the present discussion is a description of exemplary embodiments only and is not to be construed as limiting the broader aspects of the present invention.

The present invention provides a sustainable biocomposite material comprising a biodegradable polymer matrix reinforced with a combination of fillers, designed for enhanced mechanical strength and thermal insulation. The method for producing the biocomposite material comprises processing a biodegradable polymer, incorporating a volcanic stone filler as a reinforcing agent, blending plant biomass for improved insulation, introducing controlled air bubbles to optimize thermal performance, and molding the material into structural components.

The present invention provides solution to multiple environmental and an innovative building application for modern construction. It uses a domestic waste such as Volcanic Stone which can be gathered from domestic industrial area. The conversion of the fine material into a concrete aggregate helps not only in waste reduction accumulated in landfills but also in the enrichment of the properties of concrete. The second part of the composite involves biodegradable polymer comprising polylactic acid (PLA) which may be collected from 3D printer leftovers in institute laboratory, which is a replacement for petroleum derived plastic materials. Since the polymer is biodegradable, it reduces the great deal of discarded plastic in the waste environment and has a thermoplastic property suitable for modern composite manufacturing. The present invention also includes plant biomass that further extends the repertoire of materials currently being retrieved from the waste stream. This component not only reduced waste from agriculture but also contribute organics that enhance the composite performance and appearance. Furthermore, the composite shows better properties which is used in civil engineering application. Its compression resistance and high thermal insulation offers structural strength and makes an energy saving building material, which meets construction requirements in terms of strength and energy efficiency. Another use for this composite lies in its marine capabilities. Further, the biocomposite is highly resistant to corrosion and strong, and are used for different applications on boats, docks and marine infrastructure

According to a first aspect of the present invention, there is provided a biocomposite material comprising a biodegradable polymer matrix; and a combination of fillers selected from the group consisting of volcanic stone, plant biomass, and silica.

In some embodiments, the combination of fillers comprises a combination of volcanic stone and plant biomass. In other embodiments, the combination of fillers comprises a combination of volcanic stone and silica. In other embodiments, the combination of fillers comprises a combination of olcanic stone, plant biomass, and silica.

In some embodiments, the composite comprises at least 50 wt. % of the biodegradable polymer based on the total weight of the composite. For example, the composite may comprise at least 60 wt. %, at least 70 wt. %, or at least 75 wt. % of the biodegradable polymer. In some embodiments, the composite comprises the biodegradable polymer in an amount between about 50 wt. % to about 90 wt. %. For example, the composite comprises the biodegradable polymer in an amount between about 60 wt. % to about 80 wt. %, between about 65 wt. % to about 80 wt. %, or between about 70 wt. % to about 80 wt. %. In a preferred embodiment, the composite comprises the biodegradable polymer in an amount between 70 wt. % to about 80 wt. %.

In some embodiments, the composite comprises up to 50 wt. % of the volcanic stone based on the total weight of the composite. For example, the composite may comprise up to 40 wt. %, up to 35 wt. %, up to 30 wt. % or up to 25 wt. % of the volcanic stone. In some embodiments, the composite comprises the volcanic stone in an amount between about 5 wt. % to about 50 wt. %. For example, the composite comprises the volcanic stone in an amount between about 10 wt. % to about 40 wt. %, between about 10 wt. % to about 30 wt. %, or between about 15 wt. % to about 25 wt. %. In a preferred embodiment, the composite comprises the volcanic stone in an amount between 15 wt. % to about 25 wt. %.

In some embodiments, the composite comprises up to 20 wt. % of the plant biomass based on the total weight of the composite. For example, the composite may comprise up to 15 wt. %, up to 10 wt. % or up to 5 wt. % of the plant biomass. In some embodiments, the composite comprises the plant biomass in an amount between about 1 wt. % to about 20 wt. %. For example, the composite comprises the plant biomass in an amount between about 1 wt. % to about 15 wt. %, between about 1 wt. % to about 10 wt. %, or between about 1 wt. % to about 5 wt. %. In a preferred embodiment, the composite comprises the plant biomass in an amount between 1 wt. % to about 5 wt. %. More preferably, the composite comprises the plant biomass in an amount between 2 wt. % to about 3 wt. %.

In some embodiments, the composite comprises up to 20 wt. % of the silica based on the total weight of the composite. For example, the composite may comprise up to 15 wt. 00 up to 10 wt. % or up to 5 wt. % of the silica. In some embodiments, the composite comprises the silica in an amount between about 1 wt. % to about 20 wt. %. For example, the composite comprises the silica in an amount between about 1 wt. % to about 15 wt. %, between about 1 wt. % to about 10 wt. %, or between about 1 wt. % to about 5 wt. %. In a preferred embodiment, the composite comprises the silica in an amount between 1 wt. % to about 5 wt. %. More preferably, the composite comprises the silica in an amount between 2 wt. % to about 3 wt. %.

In some embodiments, the composite comprises at least 50 wt. % of the biodegradable polymer, up to 50 wt. % of the volcanic stone, up to 20 wt. % of the plant biomass and up to 20 wt. % of the silica, based on the total weight of the composite. In a preferred embodiment, the composite comprises at least 70 wt. % of the biodegradable polymer; up to 30 wt. % of the volcanic stone, up to 5 wt. % of the plant biomass and up to 5 wt. % of the silica, based on the total weight of the composite. In some examples, the composite comprises about 75 wt. % of biodegradable polymer; about 20 wt. % of volcanic stone, about 2.5 wt. % of plant biomass, and about 2.5 wt. % of silica.

In some embodiments, the biodegradable polymer is polylactic acid (PLA). The biodegradable polymer may have an average particle size ranging from 30 μm to 100 μm. For example, the biodegradable polymer may have an average particle size ranging from 40 μm to 90 μm, from 45 μm to 80 μm (preferably from 50 μm to 70 m).

In some embodiments, the volcanic stone is Volcanic Stone Micro Grounded Powder (VSMGP). The volcanic stone may have an average particle size ranging from from 130 μm to 200 μm. For example, the volcanic stone may have an average particle size ranging from 140 μm to 190 μm, from 145 μm to 180 μm (preferably from 150 μm to 170 m).

In some embodiments, the plant biomass is obtained from a group comprising palm tree, sugarcane, rice husk, coconut coir, corn stover, wheat straw, wood residues, switch grass, or mixtures thereof. Preferably, the plant biomass is obtained from palm tree. For example, the plant biomass may be palm waste. The plant biomass may have an average particle size ranging from from 100 μm to 150 μm. For example, the plant biomass may have an average particle size ranging from 110 μm to 140 μm, from 115 μm to 135 μm (preferably from 120 μm to 130 μm).

In some embodiments, the plant biomass is palm waste, the volcanic stone is Volcanic Stone Micro Grounded Powder (VSMGP), and the silica is sand silica. The combination of fillers may be referred to as reinforcement particles. The combination of fillers may be dispersed within the biodegradable polymer matrix. For example, the plant biomass, the volcanic stone, and the silica may be dispersed within the biodegradable polymer matrix.

In some embodiments, the biocomposite material is a sustainable composite material, wherein the composite material is used in making a thermally insulating and structurally reinforced composite panel, a thermally efficient construction material, a construction material for marine application, a prefabricated construction panel, and a corrosion-resistant composite material.

In another embodiment, the present invention provides that the sustainable hybrid composite material has a compressive strength of more than 60 MPa demonstrating improved load-bearing capacity suitable for construction applications, yield strength of more than 60 MPa enhancing resistance to plastic deformation under applied stress, elastic modulus of more than 2700 MPa making the material ideal for applications requiring high structural rigidity, and toughness of more than 40 MPa providing improved energy absorption and fracture resistance under dynamic loading conditions. In another embodiment, the present invention provides that the composite material has a thermal insulation value of below 5 mK/V, reducing heat transfer and improving energy efficiency in insulation applications. The high-strength biocomposite material being lightweight, exhibits improved compressive strength, yield strength, and elastic modulus due to the integration of VSMGP and palm waste fibers, making it suitable for structural, insulation, and marine applications.

In an embodiment, the present invention provides a biocomposite material comprising: a biodegradable polylactic acid (PLA) polymer, a VSMGP in an amount ranging from about 10 to 30% by wt., and a palm waste retrieved from an agricultural waste stream in an amount ranging from about 1 to 5% by wt. The biocomposite material may further comprise silica (preferably sand silica). The silica may be present in an amount ranging from about 1 wt. % to 5 wt. %.

According to an aspect of the present invention, there is provided a panel comprising the biocomposite material according to the first aspect described herein.

According to a second aspect of the present invention, there is provided a method of manufacturing a biocomposite material. The method comprises the steps of: obtaining a biodegradable polymer; obtaining at least one filler selected from volcanic stone, plant biomass, and silica, or combinations thereof; mixing the biodegradable polymer and the at least one filler to form a biodegradable polymer matrix; and molding the biodegradable polymer matrix to form the biocomposite material.

The biocomposite material may be the biocomposite material as defined according to the first aspect of the invention described herein. In an embodiment, the present invention provides that the method of manufacturing a biocomposite material comprises: obtaining a PLA polymer; obtaining at combination of fillers comprising a VSMGP, a palm waste and sand silica; mixing the biodegradable polymer and the combination of fillers to form a biodegradable polymer matrix; and molding the biodegradable polymer matrix to form the biocomposite material. The biodegradable polymer matrix may be compressed or moulded by any conventional method.

In some embodiments, the biodegradable polymer is polylactic acid (PLA), the volcanic stone is VSMGP, the plant biomass is obtained from a group comprising palm tree, sugarcane, rice husk, coconut coir, corn stover, wheat straw, wood residues, switch grass, or mixtures thereof, and wherein the silica is sand silica.

In some embodiments, before mixing the biodegradable polymer and the at least one filler to form the biodegradable polymer matrix, the volcanic stone is crushed to a fine powder and then sieved to a size ranging from 30 μm to 100 μm (preferably from 50 μm to 70 m).

In some embodiments, before mixing the biodegradable polymer and the at least one filler to form the biodegradable polymer matrix, the plant biomass is grinded to fine powder and dried at a temperature ranging from 30-70° C. (preferably 40-60° C.) followed by sieving to size ranging from 130 μm to 200 μm (preferably from 150 μm to 170 m).

In some embodiments, before mixing the biodegradable polymer and the at least one filler to form the biodegradable polymer matrix, the sand silica is dried at a temperature ranging from 60-95° C. (preferably 70-90° C.), followed by grinding and sieving to size ranging from 100 μm to 150 μm (preferably from 120 μm to 130 m).

In some embodiments, the mixing is carried out for a time ranging from 2 minutes to 20 minutes (preferably 5 minutes to 15 minutes) at a speed ranging from 30 rpm to 80 rpm (preferably 45 rpm to 65 rpm).

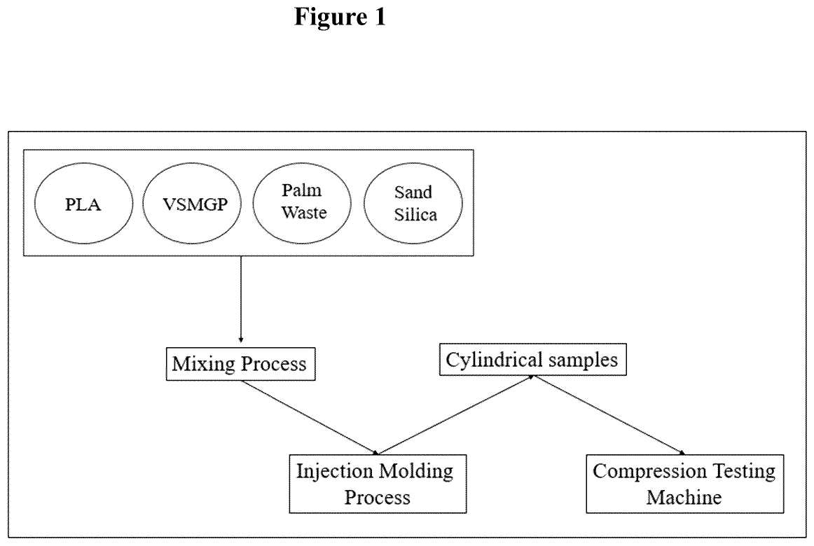

FIG. 1 provides a schematic representation describing the process for preparation of a biocomposite material according to the present invention. First, the raw materials are combined, beginning with a mixing process to ensure an even distribution of each component. Once thoroughly mixed, the material undergoes injection molding to form cylindrical samples, which represent the final biocomposite structure. These cylindrical samples are then subjected to compression testing, a process that measures their mechanical properties, such as strength and durability. The results from the compression test are recorded and displayed, showing how different material compositions impact

According to an aspect of the invention, there is provided a biocomposite material obtained by the method of manufacturing a biocomposite material according to the second aspect of invention described herein.

According to a third aspect of the present invention, there is provided a structurally reinforced composite panel comprising a first layer comprising a first biodegradable polymer matrix and a volcanic stone; and a second layer comprising a second biodegradable polymer matrix and a plant biomass. The structurally reinforced composite panel may comprise a biocomposite material according to the first aspect of the present invention.

The first layer may be referred to herein as the ‘inner layer’ and the second layer may be referred to herein as the ‘outer layer’.

In some embodiments, the composite panel comprises air pockets (also referred to herein as ‘air bubbles’) between the first layer and the second layer.

In some embodiments, the second layer further comprises the volcanic stone. For example, the second layer may comprise a second biodegradable polymer matrix, a plant biomass and the volcanic stone.

In some embodiments, the first layer consists essentially of (or consists of) a first biodegradable polymer matrix and a volcanic stone; and the second layer consists essentially of (or consists of) a second biodegradable polymer matrix, a plant biomass and the volcanic stone.

In some embodiments, the first biodegradable polymer matrix and the second biodegradable polymer are the same component. For example, the first biodegradable polymer and second biodegradable polymer may be polylactic acid (PLA).

In some embodiments, the volcanic stone is Volcanic Stone Micro Grounded Powder (VSMGP)

In some embodiments, the plant biomass is obtained from a group comprising palm tree, sugarcane, rice husk, coconut coir, corn stover, wheat straw, wood residues, switch grass, or mixtures thereof. Preferably, the plant biomass is obtained from palm tree. For example, the plant biomass may be palm waste.

In some embodiments, the plant biomass is palm waste, the volcanic stone is Volcanic Stone Micro Grounded Powder (VSMGP), and the silica is sand silica. The combination of fillers may be referred to as reinforcement particles. The combination of fillers may be dispersed within the biodegradable polymer matrix. For example, the plant biomass, the volcanic stone, and the silica may be dispersed within the biodegradable polymer matrix.

In some embodiments, the first layer has a roughness ranging from 0.3 μm to 1.3 μm, for example from 0.4 μm to 1.2 μm, from 0.5 μm to 1.0 μm, from 0.6 μm to 0.8 μm or about 0.7 μm.

In some embodiments, the second layer has a roughness ranging from 1.0 μm to 2.5 m, for example from 1.2 μm to 2.3 μm, from 1.4 μm to 2.1 μm, from 1.5 μm to 2.0 μm, from 1.6 μm to 1.9 μm, or about 1.8 μm.

The thermally insulating and structurally reinforced biocomposite panel has a dual-layered design that ensures improved toughness and compressive strength, where the inner core consists of PLA and VSMGP for mechanical reinforcement, and the outer layer integrates palm waste fibers to improve thermal resistance and surface bonding with construction materials.

The controlled air bubbles through the air compressor may play a crucial role in maintaining the thermal insulation property of the composite material. It creates a much denser and more intricate cell structure within the composite material matrix. These bubbles form isolated air chambers and decrease the material's thermal conductivity in thickness. The presence of these air bubbles thus results in the overall reduced heat transfer rate through the composite, acting as an insulator. The incorporation of air bubbles offers various advantages in terms of thermal efficiency. The trapped air creates spaces critical in reducing heat flow through the material. Regarding the balance of the thermal factor and thermal conductivity within the construction, the recurring airflow improves the thermal factor and, at the same time, reduces the thermal conductivity. Besides thermal effectiveness, this mechanism reduces the material's density while preserving the structure's solidity. This material also boasts improved sound absorption and insulation characteristics and reduced energy consumption, making it suitable for construction use. VSMGP, palm, and air bubbles make up a material with unique properties. The two give mechanical reinforcement through the VSMGP fibers, insulating properties through palm and air bubbles, and the high strength makes it suitable for building purposes. It creates a construction material that offers strength and insulation while being ideal for the wall since both are required in construction.

According to a fourth aspect of the present invention, there is provided a method of manufacturing a structurally reinforced composite panel, comprising the steps of: feeding a first biodegradable polymer matrix and a volcanic stone in an extruder and extruding as a mixture to form a first layer; and feeding a second biodegradable polymer matrix and a plant biomass in an extruder and extruding as a mixture to form a second layer; wherein the first layer and the second layer are extruded simultaneously with the first layer on top of the second layer to form the structurally reinforced composite panel.

In some embodiments, the structurally reinforced composite panel comprises the biocomposite material according to the first aspect described herein. In some embodiments, the method of manufacturing a structurally reinforced composite panel comprises the steps of the method of a biocomposite material according to the second aspect described herein.

In some embodiments, the second layer is formed by feeding the second biodegradable polymer matrix, the plant biomass and the volcanic stone in an extruder and extruding as a mixture.

In some embodiments, the biodegradable polymer is polylactic acid (PLA), the volcanic stone is VSMGP, the plant biomass is obtained from a group comprising palm tree, sugarcane, rice husk, coconut coir, corn stover, wheat straw, wood residues, switch grass, or mixtures thereof, and wherein the silica is sand silica.

In some embodiments, before extruding, the volcanic stone is crushed to a fine powder and then sieved to a size ranging from 30 μm to 100 μm (preferably from 50 μm to 70 m).

In some embodiments, before extruding, the plant biomass is grinded to fine powder and dried at a temperature ranging from 30-70° C. (preferably 40-60° C.) followed by sieving to size ranging from 130 μm to 200 μm (preferably from 150 μm to 170 m).

In some embodiments, before extruding, the sand silica is dried at a temperature ranging from 60-95° C. (preferably 70-90° C.), followed by grinding and sieving to size ranging from 100 μm to 150 μm (preferably from 120 μm to 130 m).

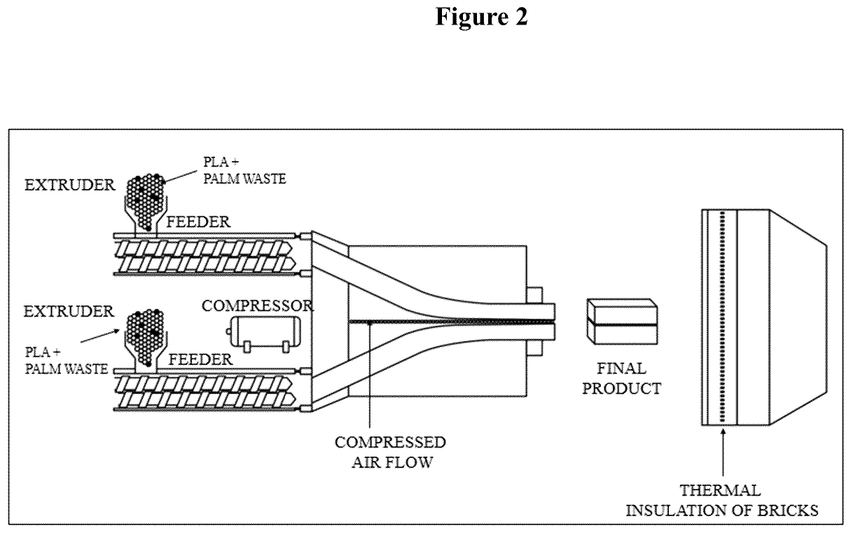

FIG. 2 provides a schematic representation of the process design of dual layered biocomposites. The dual layered composites thus prepared exhibited enhanced material strength and help to minimize the hazard materials used in constructions, and to generate new sustainable biocomposite as a substitute.

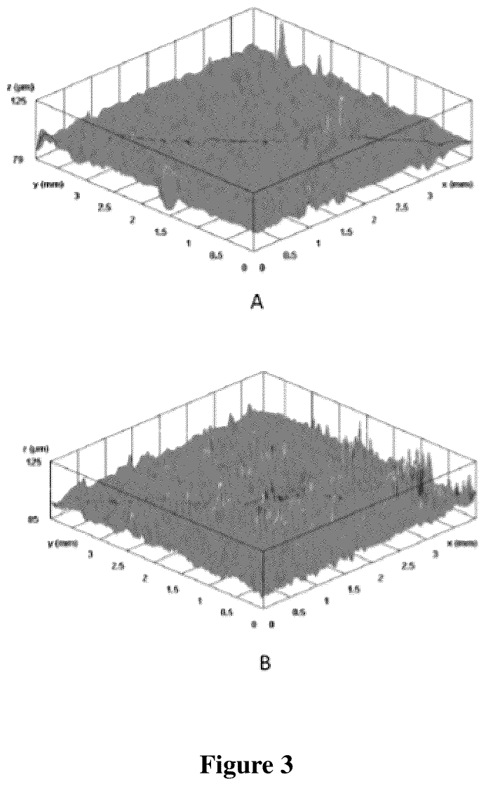

The PLA and VSMGP surface as shown in FIG. 3a, which is used for the first layer, has a surface roughness of 0.7 μm. This level of roughness is sufficient for the inner layer, as it doesn't require as much bonding strength with cement as the outer layer. The smoother surface helps provide a stable foundation within the building structure while still offering enough texture to support necessary bonding for interior applications. The PLA and VSMGP composition provides the right balance of strength and finish for the internal components of the building. Again, as shown in FIG. 3b, second layer has a significantly higher roughness, measured at 1.8 μm. The inclusion of palm waste particles increases the roughness as the particle size of the palm waste is higher, which is essential for the outer wall because it must provide a strong bond with cement. The rougher surface improves the adhesive properties of cement to guarantee interfacial adhesion to the wall. This property is essential for the outer barriers due to the susceptibility of the structures to environmental factors. Thus, the second layer (i.e. the outer layer) design ensures proper bonding process which stabilizes the structure for a long time.

Further, the present invention provides a biocomposite material comprising: a biodegradable polylactic acid polymer, a VSMGP in an amount ranging from about 10 to 30% by wt, and a palm waste retrieved from the agricultural waste stream in an amount ranging from about 1 to 5% by wt., wherein the sustainable hybrid composite material is obtainable by a method comprising: mixing PLA polymer, VSMGP, a palm waste and sand silica to obtain a mixture, the mixing is carried out for a time ranging from 5 minutes to 15 minutes at a speed ranging from 45 rpm to 65 rpm; and compressing the mixture to form a sustainable hybrid composite material.

Further, the present invention provides a structurally reinforced composite panel comprising: a first layer comprising of PLA polymer and VSMGP, a second layer comprising PLA polymer and palm waste fibers, and air bubbles in between the inner and the outer layer; wherein the composite panel is obtainable by a method comprising: feeding PLA polymer mixed with VSMGP in an extruder and extruding as a mixture to form the first layer, and feeding PLA polymer mixed with palm waste fibers in an extruder and extruding as a mixture to form the second layer, and wherein the inner layer and the outer layer are extruded simultaneously with the first layer on top of the second layer, wherein a stream of air bubbles is compressed in between the inner first and the second layer.

Further, the present invention provides the use of biocomposite material, wherein the composite material is used in making a thermally insulating and structurally reinforced composite panel, a thermally efficient construction material, a construction material for marine application, a prefabricated construction panel, and a corrosion-resistant composite material.

In an embodiment, the present invention provides a biocomposite material for marine applications comprising a biodegradable PLA polymer as binder, VSMGP particles for mechanical reinforcement, and palm waste fibers for increased thermal insulation and resistance to water and environmental degradation. Further, the biocomposite material is corrosion-resistant and designed to withstand environmental stressors such as high humidity, saltwater exposure, and extreme temperatures for use in coastal and marine environments.

In an embodiment, the present invention provides a thermally efficient composite insulation material composed of PLA polymer, VSMGP, and palm waste fibers, engineered to achieve a low thermal conductivity rating for use in energy-efficient building applications.

In an embodiment, the present invention provides a prefabricated construction panel made from a composite of PLA polymer, VSMGP, and palm waste fibers, designed for high compressive strength, thermal insulation, and optimal adhesion to cement-based structures.

The present disclosure now being generally described, it will be more readily understood by reference to the following examples, which are included merely for purposes of illustration of certain aspects and embodiments of the present disclosure and are not intended to limit the present disclosure in any way.

### Examples

Materials used:

Polylactic acid (PLA)-based biocomposites were prepared using PLA waste that was collected from 3D printing leftovers in institute laboratory, as the base component with filler materials: a Volcanic Stone Micro Grounded Powder (VSMGP), sand silica, and palm waste powder. PLA, a biodegradable polymer acted as the main matrix component. VSMGP is a domestic rock material that been found in mountains, that was used as a filler, here it was collected from Fujairah, UAE. It was crushed to a fine powder and then sieved at 60 μm. Palm waste such as leaves and rachis was gathered from local company, then grinded to fine powder and dried at 50° C. using a laboratory drying oven to minimize the residual moisture in the material, which was essential for maximizing adhesion with PLA. Finally, it was sieved at 160 μm using Auto Sieve Shaker, which ensured that all particles were uniformly sized. Lastly, local natural sand silica was sourced as filler material. The sand silica powder was collected from AlA in, UAE desert area and it was dried at 80° C. drying oven to remove the moisture content and also maximize adhesion and then grinded and sieved at 125 μm using Auto Sieve Shaker to ensure that the particles were consistently sized.

### Preparation of Composites

The composite materials were prepared mixing the PLA matrix with the three filler materials (VSMGP, palm waste, and sand silica) at specific proportions. The mixing was done using a laboratory overhead mechanical mixer under a specific speed around 55 rpm for continuous 8 min. Eight samples were prepared with a filler proportion ranging from 5% to 25% and the rest of the composite consisted of PLA as indicated in Table 1. The diverse formulations were important for assessing the effects of the different content of filler materials in the composite on the mechanical and thermal properties.

TABLE 1
Composite samples as per proportions

| Samples | PLA % | Filler % |
|---|---|---|
| 1 | 100% | 0% |
| 2 | 95% | 5% VSMGP |
| 3 | 90% | 10% VSMGP |
| 4 | 85% | 15% VSMGP |
| 5 | 80% | 20% VSMGP |
| 6 | 75% | 20% VSMGP, 5% Sand Silica |
| 7 | 75% | 20% VSMGP, 5% Palm waste |

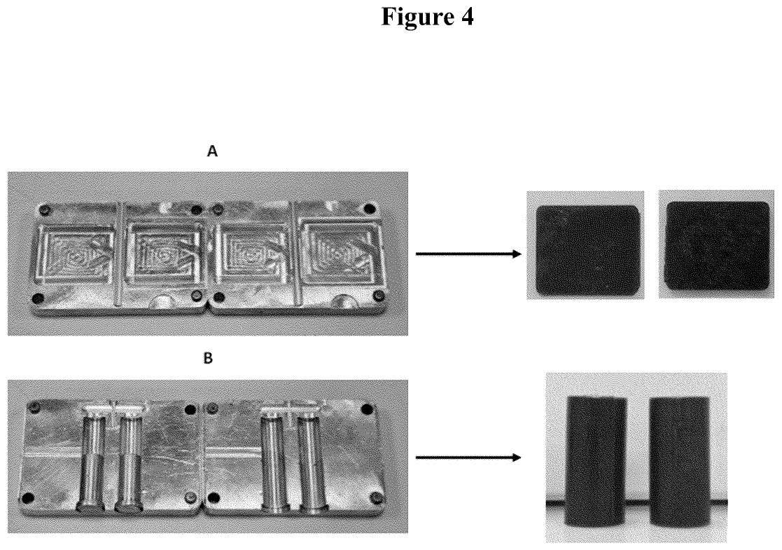

After mixing, the samples were fed into an injection molding machine to inject the composites into cylindrical and square moulds. The square samples were prepared using the square compression moulds shown in FIG. 4a. The cylindrical samples were made using cylindrical compression moulds that were specially designed for this research, using TinkerCAD a 3D design program. The 3D design was then fabricated using stainless steel at a local metal workshop as illustrated in FIG. 4b. The cylindrical moulds are essential for standardized testing procedures, which was necessary for consistency across different studies. The cylindrical moulds allowed for uniform load and stress distribution and increased accuracy while measuring the samples' compressive strength, elastic modulus, yield strength, and toughness. Square molds were advantageous in that they enabled thermal conductivity testing.

### Determination of Compression Strength

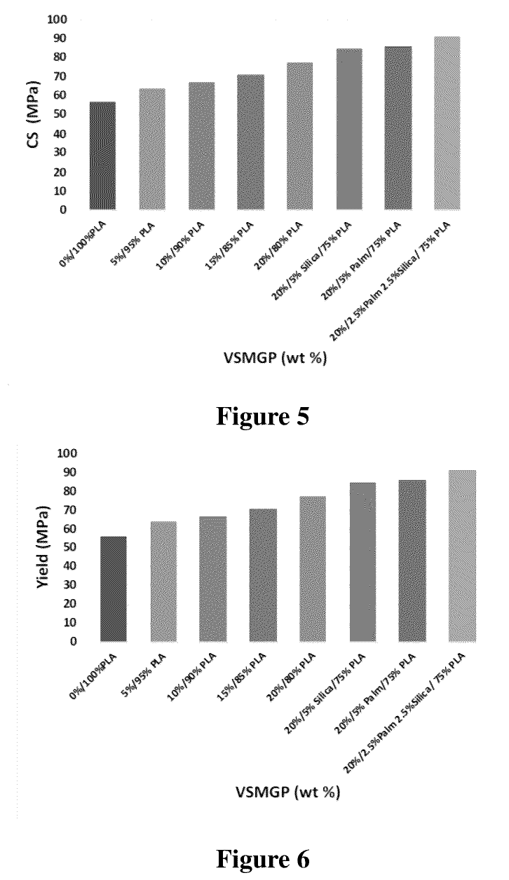

The ultimate strength of the polymer matrix increases with the introduction of VSMGP, sand silica, and palm, reflecting their reinforcing effects as shown in FIG. 5. Pure PLA exhibited an ultimate strength of 56.72 MPa. Adding 5% VSMGP increased the strength to 64.29 MPa, demonstrating the role of VSMGP in strengthening the matrix. As VSMGP content increased to 10%, ultimate strength climbed to 67.41 MPa, and at 15% VSMGP, the value reached 71.22 MPa, showing a gradual improvement. This enhancement was due to VSMGP's high mechanical strength and superior bonding with the polymer matrix, which helped distribute stress more effectively across the composite structure. Adding 20% VSMGP boosted the ultimate strength to 77.63 MPa, a significant rise attributed to VSMGP's high load-bearing capability. When 5% sand silica was added to 20% VSMGP, the ultimate strength increased to 85.03 MPa, reflecting the combined reinforcing effects of both VSMGP and sand silica. The highest strength of 91.60 MPa was observed with a mixture of 2.5% palm, 2.5% sand silica, and 20% VSMGP, which indicated that palm, despite being more flexible, enhanced strength when used in synergy with VSMGP and sand silica.

### Determination of Yield Strength

The yield strength of PLA composites as illustrated in FIG. 6 showed a clear correlation with fiber addition. Pure PLA yield at 56.03 MPa, but introducing 5% VSMGP raised this to 63.92 MPa, reflecting the stiffening effect of VSMGP fibers. As the VSMGP content was increased to 10%, yield strength raised to 66.93 MPa, and with 15% VSMGP, the strength climbed further to 70.46 MPa, demonstrating that VSMGP fibers helped resist plastic deformation under load. The maximum yield strength was achieved at 20% VSMGP with a value of 77.15 MPa, suggesting that the optimal VSMGP content for maximum yield strength lies at 20%. VSMGP fibers improve composite materials' tensile and compressive yield properties due to their high stiffness and good interfacial adhesion with the polymer matrix. The addition of 5% sand silica to 20% VSMGP increased yield strength slightly to 84.76 MPa, and when palm fibers were added to the mixture yield strength improved marginally to 85.97 MPa, reflecting the balance between the rigid VSMGP and more flexible palm fibers. The combination of 2.5% palm and 2.5% sand silica with 20% VSMGP gave the highest yield strength at 90.99 MPa, likely due to the synergy of hybrid reinforcement.

### Determination of Elastic Modulus

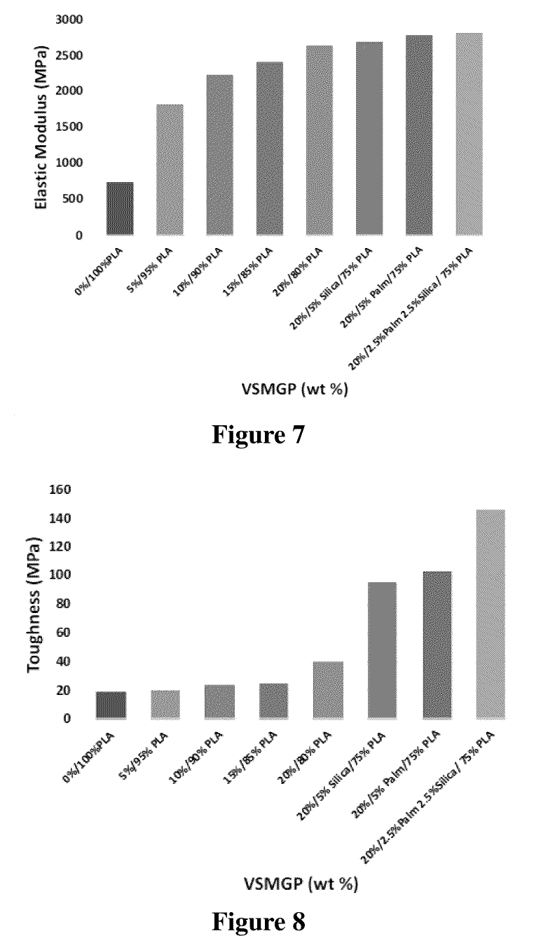

The elastic modulus of the composites increased substantially with the incorporation of VSMGP and sand silica as illustrated in FIG. 7. In particular, purely PLA demonstrated low elastic modulus value, 751 MPa, which indicated that the component was not very stiff. Incorporation of 5% VSMGP increased the modulus to 1823.97 MPa, under emphasizing the role of VSMGP on stiffness. For 10% VSMGP, the elastic modulus raised to 2231.4 MPa; at 15% VSMGP, the elastic modulus, which indicated the progressive stiffening of the matrix, was 2414 MPa. Polymers containing VSMGP fibers have a had value of the parameter of the elastic modulus that contributed to an increase in stiffness of polymer SRMs. As for increasing VSMGP content to 20%, the modulus increased to 2657 MPa, which was improving remarkably compared to previous results, showing that VSMGP could offer excellent rigidity. Adding 5% sand silica to 20% VSMGP resulted in an elastic modulus of 2704 MPa, while adding 5% palm fibers increased the modulus to 2789 MPa, reflecting palm fibers' ability to complement VSMGP in reinforcing the matrix. The combination of 2.5% palm and 2.5% sand silica with 20% VSMGP gave the highest elastic modulus of 2821 MPa, indicating that sand silica and palm contribute to both stiffness and flexibility in the composite, optimizing mechanical performance.

### Determination of Toughness

Toughness, the ability of a material to absorb energy and deform without fracturing, also improved significantly with the addition of VSMGP, sand silica, and palm. Mechanical properties of the pure PLA material revealed a tensile strength of 18.98 MPa as a measure of the material's hardness which was relatively brittle and had no fibrous reinforcement as shown in FIG. 8. The initial improvement of VSMGP fibers effect on the energy absorption ability of the composite was observed when the toughness raised to 19.93 MPa when 5% VSMGP was added. Specifically, when the VSMGP content was increased to 10%, the toughness increased to 23.36 MPa, and at 15% VSMGP the toughness increased to 24.97 MPa. VSMGP fibers improve mechanical properties such as high toughness and tensile strength, improving the composite's performance under impacts and dynamic loads. The most significant jump in toughness was observed when 20% VSMGP was used, with a value of 40.56 MPa, indicating the maximum reinforcement potential of VSMGP. When 5% sand silica were added to 20% VSMGP, the toughness value raised sharply to 95.31 MPa, reflecting the combined toughening effect of VSMGP and sand silica. Additionally, sand silica's high surface area and strong interfacial bonding with the matrix improved crack resistance, distributing stress more effectively across the composite.

### Determination of Thermal Insulation

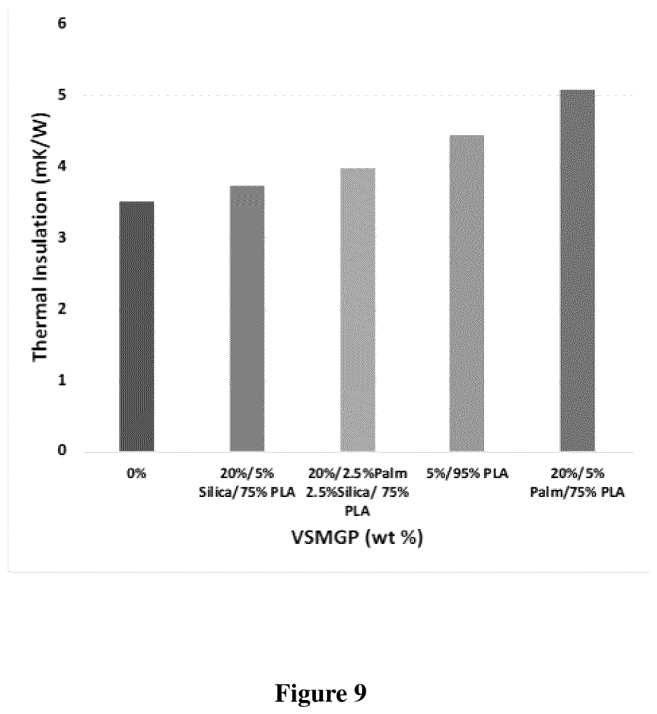

Thermal insulation properties of PLA composites are significantly influenced by the type and proportion of added sand silica and palm as shown in FIG. 9. Pure PLA's basic specific thermal conductivity was 3.50 mK/W while the composite with 5% VSMGP produced 3.72 mK/W. VSMGP fibers possessed low thermal conductivity; resulting in an improvement of the thermal insulating properties of the composites. Increasing the VSMGP content to 10% raised the insulation value to 3.96 mK/W and, further to 15% bVSMGP, brought the insulation value up to 4.42 mK/W. The thermal insulating properties increased progressively as the proportion of VSMGP rises, because of the nature of VSMGP which has inherently high thermal resistance. The maximum insulation value achieved in this study was 5.08 mK/W for an incorporation of 20% VSMGP and 5% palm. Natural fibers like palm waste fiber have good thermal insulating properties because of their low density and cellulosic structure that confines air allowing minimal heat conduction. Adding 5% sand silica to 20% VSMGP resulted in an insulation value of 4.98 mK/W, slightly lower than the palm waste mixture. This suggested that sand silica, while enhancing mechanical properties, is not as effective as palm fibers in improving thermal insulation. The best thermal insulation performance was achieved with the combination of 2.5% palm, 2.5% sand silica, and 20% VSMGP, confirming that hybrid composite combinations optimize both mechanical and thermal properties.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the spirit and scope of the invention as defined by the appended claims. Various modifications to the detailed designs as described above are possible.

1. A biocomposite material comprising:
at least 70 wt. % of a biodegradable polymer matrix; and
a combination of fillers comprising up to 30 wt. % of volcanic stone, up to 5 wt. % of plant biomass, and up to 5 wt. % of silica.

2-3. (canceled)

4. The biocomposite material according to claim 1, wherein the composite comprises 75 wt. % of biodegradable polymer; 20 wt. % of volcanic stone, 2.5 wt. % of plant biomass, and 2.5 wt. % of silica.

5. The biocomposite material according to claim 1, wherein the biodegradable polymer is polylactic acid (PLA).

6. The biocomposite material according to claim 1, wherein the volcanic stone is Volcanic Stone Micro Grounded Powder (VSMGP), and wherein the plant biomass is obtained from a group consisting of palm tree, sugarcane, rice husk, coconut coir, corn stover, wheat straw, wood residues, switch grass, or mixtures thereof.

7. The biocomposite material according to claim 1, wherein the plant biomass is palm waste, the volcanic stone is Volcanic Stone Micro Grounded Powder (VSMGP), and the silica is sand silica.

8. The biocomposite material according to claim 1, wherein the composite material has a compressive strength of more than 60 MPa, or a yield strength of more than 60 MPa, or an elastic modulus of more than 2700 MPa, or a toughness of more than 40 MPa, and wherein the composite material has a thermal insulation value of below 5 mK/V.

9. A method of manufacturing a biocomposite material, comprising the steps of:
obtaining at least 70 wt. % of a biodegradable polymer;
obtaining a combination of fillers comprising up to 30 wt. % volcanic stone, up to 5 wt. % of plant biomass, and up to 5 wt. % of silica;
mixing the biodegradable polymer and the combination of fillers to form a biodegradable polymer matrix; and
molding the biodegradable polymer matrix to form the biocomposite material.

10. The method according to claim 9, wherein the biodegradable polymer is polylactic acid (PLA), wherein the volcanic stone is VSMGP, wherein the plant biomass is obtained from a group consisting of palm tree, sugarcane, rice husk, coconut coir, corn stover, wheat straw, wood residues, switch grass, or mixtures thereof, and wherein the silica is sand silica.

11. The method according to claim 9, wherein before mixing the biodegradable polymer and the combination of fillers to form the biodegradable polymer matrix, the volcanic stone is crushed to a fine powder and then sieved to a size ranging from 50 μm to 70 μm, the plant biomass is grinded to fine powder and dried at a temperature ranging from 40-60° C. followed by sieving to size ranging from 150 μm to 170 μm, and the silica is dried at a temperature ranging from 70-90° C., followed by grinding and sieving to size ranging from 120 μm to 130 μm.

12. The method according to claim 9, wherein the mixing is carried out for a time ranging from 5 minutes to 15 minutes at a speed ranging from 45 rpm to 65 rpm.

13. A structurally reinforced composite panel comprising:
a first layer comprising a first biodegradable polymer matrix and a volcanic stone; and
a second layer comprising a second biodegradable polymer matrix and a plant biomass.

14. The composite panel according to claim 13, further comprising air pockets between the first layer and the second layer.

15. The composite panel according to claim 13, wherein the second layer further comprises the volcanic stone.

16. The composite panel according to claim 13, wherein the first biodegradable polymer and second biodegradable polymer are polylactic acid (PLA), wherein the volcanic stone is VSMGP, and wherein the plant biomass is obtained from a group comprising palm tree, sugarcane, rice husk, coconut coir, corn stover, wheat straw, wood residues, switch grass, or mixtures thereof.

17. The composite panel according to claim 13, wherein the first layer has a roughness ranging from 0.5 to 1 μm, and the second layer has a roughness ranging from 1.5 to 2 μm.

18. A method of manufacturing a structurally reinforced composite panel, comprising the steps of:
feeding a first biodegradable polymer matrix and a volcanic stone in an extruder and extruding as a mixture to form a first layer; and
feeding a second biodegradable polymer matrix and a plant biomass in an extruder and extruding as a mixture to form a second layer;
wherein the first layer and the second layer are extruded simultaneously with the first layer on top of the second layer to form the structurally reinforced composite panel.

19. The method according to claim 18, wherein the second layer is formed by feeding the second biodegradable polymer matrix, the plant biomass and the volcanic stone in an extruder and extruding as a mixture.

20. The process as claimed in claim 18, wherein before extruding, the volcanic stone is crushed to a fine powder and then sieved to a size ranging from 50 μm to 70 μm, the plant biomass is dried at a temperature ranging from 40-60° C. followed by sieving to size ranging from 150 μm to 170 μm, and the sand silica is dried at a temperature ranging from 70-90° C., followed by grinding and sieving to size ranging from 120 μm to 130 μm.
